(19) United States
(12) Patent Application Publication
(10) Pub. No.: US 2019/0263519 A1
(43) Pub. Date: Aug. 29, 2019

(54) HYBRID AIRCRAFT

(71) Applicant: Hybridskys Technology Pty Ltd, Mount Hawthorn WA (AU)

(72) Inventor: Murray Argus, Mount Hawthorn WA (AU)

(73) Assignee: Hybridskys Technology Pty Ltd, Mount Hawthorn WA (AU)

(21) Appl. No.: 16/343,700

(22) PCT Filed: Oct. 24, 2017
(86) PCT No.: PCT/AU2017/051162

§ 371 Date: Apr. 19, 2019

(30) Foreign Application Priority Data
Oct. 24, 2016 (AU) 2016904322
Jan. 18, 2017 (AU) 2017900145

(51) Int. Cl. B64C 39/02; B64D 27/02

(52) U.S. Cl. CPC B64C 39/024; B64D 27/02; B64C 2201/042; B64D 2027/026; B64C 2201/027; B64C 2201/165; B64C 2201/044

(57) ABSTRACT

A hybrid aircraft comprises at least three independent electric motors each arranged to drive a respective rotor; and an internal combustion engine arranged to drive at least two rotor, which are preferably horizontally spaced apart. There is also a controller for providing speed control signals to the electric motor driven rotors and a throttle control signal for controlling the throttle of the internal combustion engine, based on a flight control signal.

### FIELD OF THE INVENTION

The present invention relates to a hybrid aircraft.

### BACKGROUND

Remotely operated aircraft such as drones (also called unmanned aerial vehicles (UAV)) are known for being able to fly under remote or autonomous control. These aircraft are subject to operating limitations. Commonly they are only able to fly for less than an hour at a time with a range of 2 km or less. There are three known categories of drones—fixed wing drones; rotary (multi-rotor) drones; and fixed-wing hybrid Vertical Take Off and Landing (VTOL) drones.

Fixed wing drones, if combined with a fuel engine, can stay aloft for up to 16 hours at a time. However, the disadvantage of a fixed wing drone is that it cannot hover, and they have limited manoeuvrability due to the need for forward motion to maintain lift from the wings. Rotary drones do not suffer from this shortfall, being able to hover. However, rotary drones and are only able to stay in the air (termed endurance time) for up to 30 minutes at a time (this time being dependent on the type of rotary drone being utilised and the storage capacity of its battery), fly slower than a fixed wing drone and have a shorter range.

It is desirable for rotary drones to have a longer endurance, however there are limitations on endurance that arise due to battery storage capacity and its corresponding weight.

The present invention seeks to overcome or at least substantially ameliorate, the disadvantages and/or shortcomings of prior systems.

Any references to documents that are made in this specification are not intended to be an admission that the information contained in those documents form part of the common general knowledge known to a person skilled in the field of the invention, unless explicitly stated as such.

### SUMMARY OF THE INVENTION

According to an aspect of the invention, there is provided a hybrid aircraft, said aircraft comprising:
at least three independent electric motors each arranged to drive a respective rotor;
an internal combustion engine arranged to drive a set of at least two horizontally spaced apart rotors;
a controller for receiving a flight control signal and for outputting a speed control signal for each electric motor and a throttle control signal for the internal combustion engine,
   wherein the throttle control signal determines the speed of rotation of the set of at least two horizontally spaced apart rotors.

In an embodiment, the set of at least two rotors comprises two rotors only. In an embodiment the rotors are positioned longitudinally spaced apart relative to a body of the aircraft.

In an embodiment, the internal combustion engine drives the two rotors so as to be counter rotating. In an embodiment the axes of rotation of the two rotors are vertical and fixed.

In an embodiment, the drive of the counter rotating two rotors is by a mechanical drive train.

In an embodiment, the internal combustion engine is connected to the set of two rotors by a belt drive mechanism.

In an embodiment, the controller is configured such that the throttle control signal controls the internal combustion engine, so that the set of two rotors provides a substantial component of an overall lift force applied to the hybrid aircraft. In an embodiment the substantial component is the majority.

In an embodiment, the controller is configured such that the speed control signal for each electric motor controls each respective electric motor to provide a manoeuvring thrust for the hybrid aircraft according to the flight control signal.

In an embodiment, the speed control signal for each electric motor controls each respective electric motor to provide a contribution to the overall lift force.

In an embodiment, the controller comprises a flight control system for determining combined lift and manoeuvring control signals for controlling flight of the hybrid aircraft.

In an embodiment, the contribution to the overall lift of each electric motor driven rotor is substantially constant, subject to manoeuvring thrust variations.

In an embodiment, the contribution to the overall lift of each electric motor driven rotor is substantially as required to maintain each electric motor at an energy consumption efficient speed.

In an embodiment, the manoeuvring control signal is superimposed over the contribution of lift for each electric motor driven rotor signal, for each electric motor.

In an embodiment, the speed control signal for each electric motor varies substantially only for stabilisation and manoeuvring purposes.

In an embodiment, the counter rotation of the set of two rotors creates a neutral angular momentum.

In an embodiment, a combined rotational force produced by the set of rotors is counteracted by a combined rotation force produced by the electric motor driven rotors.

In an embodiment, the system has a failure detector, which sends a failure signal to the flight control system in the event of a failure.

In an embodiment, the controller comprises a logic element for splitting the speed control signals from the flight control system into the speed control signals for each electric motor and the throttle control signal.

In an embodiment, the controller comprises a logic element for splitting the flight control signal into a control signal input into a speed control system and the throttle control signal.

In an embodiment, the diameters of the at least three independent electric motor driven rotors are substantially the same.

In an embodiment, the diameters of each of the set of at least two rotors are substantially the same.

In an embodiment, the diameters of each of the set of at least two rotors are larger than the diameters of the at least three independent electric motor driven rotors.

In an embodiment, the drive of the two counter rotating rotors is by the internal combustion engine motivating an electrical generator which in turn drives at least one electric motor configured to mechanically drive the counter rotating rotors.

According to an aspect of the invention, there is provided a controller system for a hybrid aircraft, said controller system comprising:
a receiver of a flight control signal;
a flight control system for creating a combined lift and manoeuvring signal for each of at least three electric motors from the flight control signal;
a logic element for creating a lift control signal derived from the combined lift and manoeuvring signal or the control signal, whereby in use the combined signals control the speed of the respective electric motor so as to rotate a respective rotor and the lift control signal controls a throttle of an internal combustion engine.

In an embodiment, the logic element receives the flight control signal and creates the lift control signal from the control signal, whereby in use the combined signals control the speed of the respective electric motor so as to rotate a respective rotor and the lift control signal controls a throttle of an internal combustion engine.

In an embodiment, the logic element receives the combined lift and manoeuvring signals and creates the lift control signal therefrom and creates adapted lift and manoeuvring signals for the electric motors.

In an embodiment, the lift and manoeuvring signals for the electric motors are used to stabilise and manoeuvre the hybrid aircraft.

In an embodiment, the lift control signal for the throttle of the internal combustion engine is used to provide a substantial portion, and preferably the majority, of lift to the hybrid aircraft.

According to an aspect of the invention, there is provided a method for operating a hybrid aircraft, said method comprising:
receiving a flight control signal;
adapting the control signal into a speed control signal for each of a plurality of independent electric motors for driving a respective rotor and a throttle control signal for an internal combustion engine for driving a set of at least two rotors;
driving the respective rotors using the plurality of electric motors each at a speed according to the respective speed control signal;
driving the set of at least two rotors using the internal combustion engine at a speed according to the throttle control signal.

According to an aspect of the invention, there is provided a computer program comprising instructions for controlling a processor to perform the method defined above.

According to an aspect of the invention, there is provided a computer program in the form of instructions stored in a non-volatile manner in a hybrid aircraft for controlling a processor to:
receive a flight control signal;
adapt the control signal into a speed control signal for each of a plurality of independent electric motors for driving a respective rotor and a throttle control signal for an internal combustion engine for driving a set of at least two rotors.

According to an aspect of the invention, there is provided a hybrid aircraft, said aircraft comprising:
at least three independent electric motors each arranged to drive a respective rotor;
an internal combustion engine arranged to drive a set of two horizontally spaced apart counter rotating rotors with fixed vertical axes of rotation.

According to an aspect of the invention, there is provided a hybrid aircraft, said aircraft comprising:
at least three independent electric motors each arranged to drive a respective rotor;
an internal combustion engine arranged to drive at least one rotor, wherein the electric motor driven rotors provide a counter-rotational force to the rotational force of the internal combustion engine driven at least one rotor.

According to an aspect of the invention, there is provided a hybrid aircraft, said aircraft comprising:
at least three independent electric motors each arranged to drive a respective rotor for manoeuvring the hybrid aircraft;
at least two electric motor powered horizontally spaced apart rotors with fixed vertical axes of rotation for lifting the hybrid aircraft;
an internal combustion engine arranged to drive a generator;
   wherein an electric motor for driving the or for each of the at least two rotors is powered by the generator.

According to an aspect of the invention, there is provided a hybrid aircraft, said aircraft comprising:
an internal combustion engine arranged to drive a generator;
a controller for outputting a control signal for controlling the speed of rotation of at least three electronic motor powered rotors for manoeuvring the hybrid aircraft, and for outputting a signal for controlling the speed of rotation of at least two electric motor powered rotors for lifting the hybrid aircraft; wherein an electric motor for driving the or each of the at least two rotors is powered by the generator.

In an embodiment the rotors for lifting the hybrid aircraft provide substantially more lift per revolution per minute than the lift produced by the rotors for manoeuvring the hybrid aircraft.

In an embodiment the rotors for lifting are substantially larger in diameter than the rotors for manoeuvring.

In an embodiment the rotors for lifting are positioned along a central axis of the hybrid aircraft.

In an embodiment the generator is an alternator.

In an embodiment the hybrid aircraft comprises a power circuit which includes the generator.

In an embodiment the power circuit comprises a rectifier for rectifying power received from the generator.

In an embodiment the controller further comprises electronic speed controllers for controlling the speed of each respective electric motor for driving the respective one of the rotors for lifting the hybrid aircraft.

In an embodiment the power circuit provides a power input to the electronic speed controllers for powering the electric motors for rotating the lift rotors.

In an embodiment the internal combustion engine is arranged to be controlled by a throttle control signal and the power output from the generator directly controls the at least two electric motors.

In an embodiment the power circuit further comprises a regulator for regulating the power from the rectifier.

In an embodiment the hybrid aircraft further comprises a battery for powering the manoeuvring electric motors.

In an embodiment power from the generator is used to charge the battery.

In an embodiment the hybrid aircraft further comprises a second battery for powering the lift electric motors, and power from the generator is used to charge the second battery.

In an embodiment, the alternator is a three phase alternator. In an embodiment the regulator outputs a first power output for the speed controllers of the lift rotors and or the second battery. In an embodiment the regulator outputs a second power output for the speed controllers of the manoeuvring rotors and or the first battery.

According to an aspect of the invention, there is provided a hybrid aircraft, said aircraft comprising:
at least three of the rotors for manoeuvring the hybrid aircraft;
at least two horizontally spaced apart rotors with fixed vertical axes of rotation for providing lift to the hybrid aircraft, wherein the rotors for lifting the hybrid aircraft provide substantially more lift per revolution per minute than the lift produced by the rotors for manoeuvring the hybrid aircraft.

Throughout the specification and claims, unless the context requires otherwise, the word “comprise” or variations such as “comprises” or “comprising”, will be understood to imply the inclusion of a stated integer or group of integers but not the exclusion of any other integer or group of integers.

### DESCRIPTION OF DRAWINGS

In order to provide a better understanding of the present invention embodiments will now be described, by way of example only, with reference to the drawings, in which:

FIG. 1 is a schematic top view of a hybrid aircraft according to an embodiment of the present invention.

FIG. 2 is a schematic side view of the hybrid aircraft of FIG. 1.

FIG. 3 is a diagram of an embodiment of a control system for the embodiment of the hybrid aircraft of FIG. 1.

FIG. 4 is a diagram of an alternative embodiment of a control system for the embodiment of the hybrid aircraft of FIG. 1.

FIG. 5 is a flow chart of an embodiment of a method of controlling the hybrid aircraft of FIG. 1.

FIG. 6 is a flow chart of a method of powering the hybrid aircraft according to an embodiment of the present invention.

FIG. 7 is a flow chart of a method of controlling the hybrid aircraft according to an embodiment of the present invention.

FIG. 8 is a top view of a preferred embodiment of the present invention.

FIG. 9 is a diagram illustrating control of a hybrid aircraft according to an embodiment of the present invention.

FIG. 10 is an electrical diagram illustrating power circuit connections between components.

FIG. 11 is an expanded electrical diagram of the circuit of FIG. 10, according to an embodiment of the present invention.

FIG. 12 is an expanded electrical diagram of the circuit of FIG. 10, according to an embodiment of the present invention.

FIG. 13 is an expanded electrical diagram of the circuit of FIG. 10, according to an embodiment of the present invention.

FIG. 14 is an expanded electrical diagram of the circuit of FIG. 10, according to a preferred embodiment of the present invention.

### DETAILED DESCRIPTION

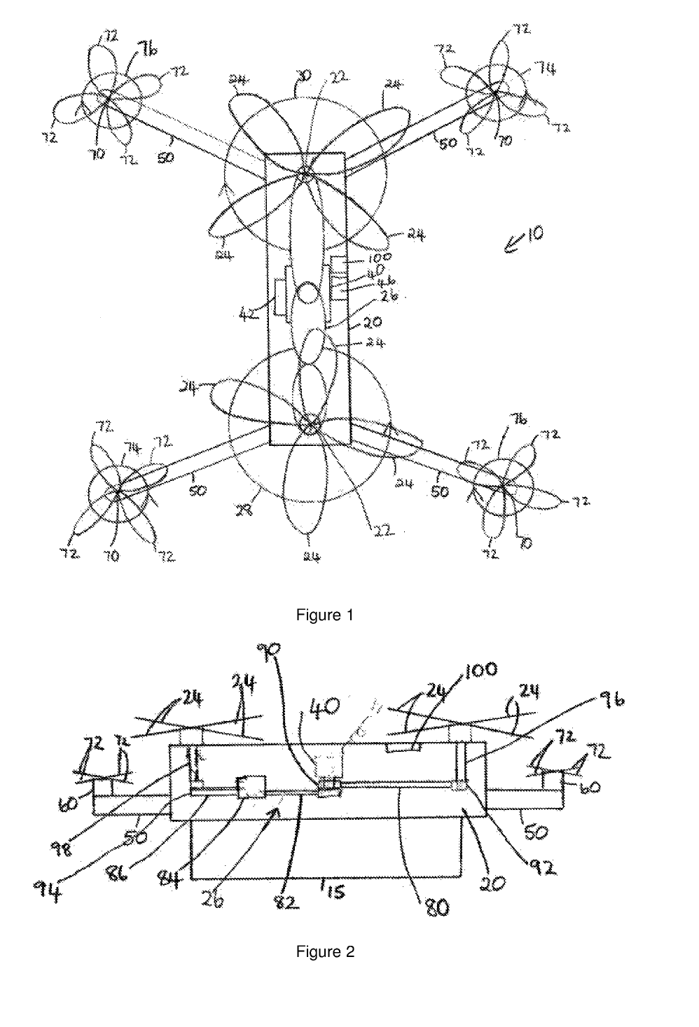

Referring to FIG. 1, there is a schematic illustration of an unmanned hybrid aircraft 10. This embodiment of the aircraft does not have wings. The hybrid aircraft 10 is elongate in overall shape when viewed from above and comprises an elongate, generally rectangular chassis 20. Mounted to the chassis 20 are a plurality of arms 50, each of which mounts an electric motor 60 at a distal end. Each electric motor 60 has a rotor 72 coupled thereto. The chassis 20 and/or arms 50 may be formed of Aluminium or Fibre Reinforced Polymer, for example.

For three-dimensional manoeuvring the minimum number of rotors is three. In this embodiment there are four, but it is also likely that six or eight will be commonly used. Other numbers are possible.

Mounted to the chassis 20 are a set of rotors 24. The set of rotors 24 are spaced apart horizontally, preferably at different locations along the length of the chassis 20. In this embodiment there are two rotors 24 on the central axis of the chassis 20. In an alternative they may be arranged to be on either side of the central axis lifting the centre of gravity of the aircraft (without payload). The rotors 24 are mounted at their centres 22 to the chassis 20 in a manner that allows them to rotate about a fixed vertical axis. In this embodiment, the rotors 24 are driven by an internal combustion engine 40 linked to the rotors 24 by a drive system 26, which in this embodiment comprises pulleys, a gear box and belts 26. The drive system 26 is used to drive the rotors 24 in a counter rotating manner, as shown by the rotation directions 28 and 30. Thus the rotors 24 have blades pitched in opposite directions so that their respective rotation each causes a lift thrust, and together the combined lift thrust is able to support the aircraft, without need for additional lift thrust, as discussed in more detail below. Thus the aircraft can achieve VTOL.

In this embodiment the internal combustion engine 40 is mounted to the chassis 20 between the rotors 24, but in other embodiments it may be located at an end of the chassis 20. The internal combustion engine 40 consumes fuel from a fuel tank 42.

In this embodiment the rotors 24 are the same diameter, and are larger than the rotors 72, which are the same diameter.

The arms 50 are shown extending at an acute angle to the chassis 20, however in other embodiments they may extend perpendicular to the length of the chassis 20. They may extend radially from a centre point or centre of gravity of the aircraft 10. Each electric motor 60 preferably drives a respective shaft 70 which rotates a respective one of the rotors 72 in a known rotation manner about a vertical fixed axis of rotation. Preferably a pair of diagonally opposite rotors 72 rotate their blades in the same direction as shown at 74, and another pair of diagonally opposite rotors 72 rotate their blades in the opposite direction to 74, as shown by 76.

The drive system 26 in the embodiment shown in FIG. 2 has a double pulley mounted to the internal combustion engine 40 drive shaft. There is a respective belt driven by each pulley of the double pulley 90. One of the belts 80 (in this case towards the top of page in FIG. 1 and left of page in FIG. 2) connects to a pulley 92 mounted to a shaft 96 connected to a respective rotor 24. The other of the belts 82 (lower on the page in FIG. 1 and left of page in FIG. 2) connects to and drives a pulley of a gear box 84. The gear box 84 has a second pulley linked by gears that rotates in the opposite direction to the direction of rotation of its first pulley. The second pulley of the gear box drives a third belt 86 which connects to a pulley 94 mounted to a shaft 98 connected to the other rotor 24. Preferably the gears maintain a 1:1 ratio. The belts preferably comprise internal sprockets, so as to maintain synchronisation and avoid slippage, and may be timing belts.

The drive system 26 may be implemented in a different manner, provided that in this embodiment the internal combustion engine 40 drives the rotors 24 at the same speed, but in opposite directions, so that rotational torque caused by one rotor 24 is counteracted by the other rotor 24. For example, the drive system 26 may be implemented by use of axially rotating drive shafts instead of the belts.

The speed of rotation of the rotors 72 is independently controlled by the speed of rotation of each electric motor 60. Each electric motor 60 rotates at a speed according to a respective speed control signal received by the respective electric motor 60. The speed of rotation of the rotors 24 is controlled by a throttle which determines the amount of fuel combusted in the internal combustion engine 40. The throttle is typically controlled by a throttle servo-motor which in turn is controlled by a throttle control signal.

A controller 100 is provided that receives a flight control signal which represents overall flight control commands. According to the flight control signal, the controller 100 outputs a speed control signal for controlling the speed of each electric motor and a throttle control signal for the throttle servo-motor to control the speed of the internal combustion engine. Thus the speeds of the rotors 72 are independently controlled and the speed of the rotors 24 is collectively controlled.

The chassis 20 is preferably for use in carrying a payload 15, such as for example a camera. The size and weight of the payload may vary according to operational parameters of the aircraft.

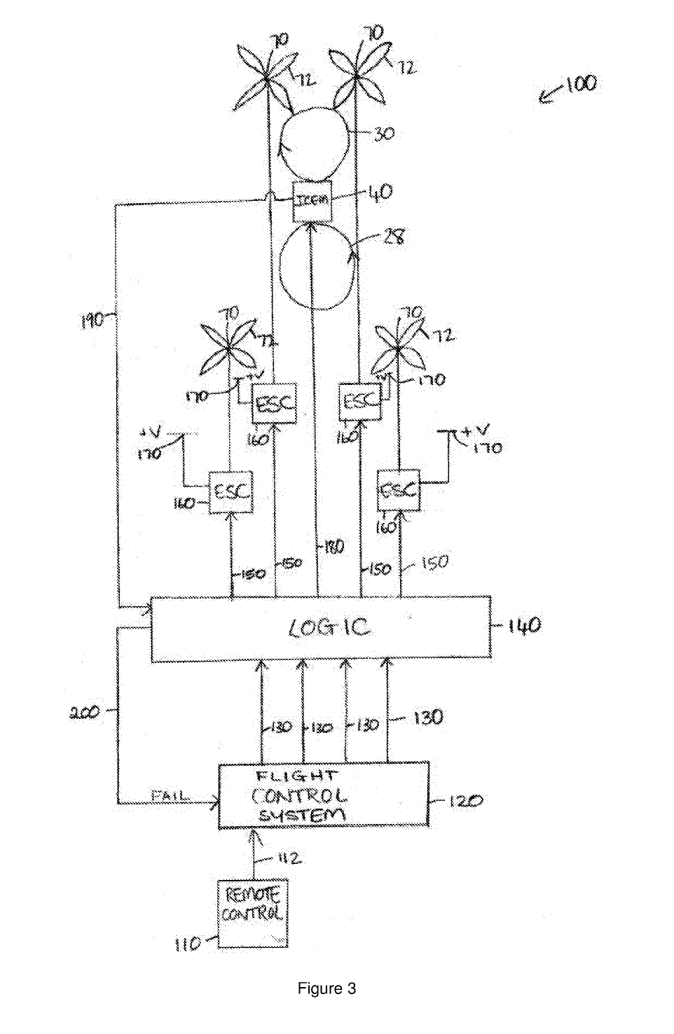

A preferred embodiment of the controller 100 is shown in FIG. 3. The controller 100 receives the flight control signal 112 from a remote control device 110. The flight control signal is typically transmitted by radio frequency signal for a remote controlled operation. However in autonomous operation the flight control signal 112 may be generated by an on-board computer system.

In an embodiment the controller 100 comprises a flight control system 120. The flight control system 120 may be an off-the-shelf flight control system, such as a DJI A2™ or DJI A3™ controller (which may comprise a Main Controller, a Power Management Unit, an Inertial Movement Unit, and a Global Navigation Satellite System). The flight control system 120 converts the flight control signal 112 to electronic speed controller signals 130 for respective electronic speed controllers for each electric motor in an off-the-shelf configuration. The signals are carried by one or more wires and they may be implemented in the form of a bus protocol, such as CAN bus.

However in this embodiment there is an interposing logic module 140 which receives electronic speed controller signals 130, (typically in the form of a pulse width modulation (PWM) signal). In this embodiment the logic module 140 creates a further set of output signals 150 for transmission to the electronic speed controllers 160 (again typically in PWM form) and a throttle control signal 180 for controlling the throttle servo-motor. The electronic speed controllers 160 are used to control the speed of rotation of the electric motors 60. The electronic speed controllers 160 are preferably powered by a voltage supply 170, preferably from a battery 46.

Speed controller signals 150 predominantly control stability and manoeuvring of the aircraft 10. The throttle control signal 180 predominantly controls lift of the aircraft 10.

The internal combustion engine 40 also receives the throttle control signal 180 from the logic 140. This is used to control the speed at which the internal combustion engine 40 operates at, by using the servo-motor to adjust the throttle of the internal combustion engine 40, and accordingly the speed at which the rotors 24 rotate.

There is also provided a feedback signal 190 from the internal combustion engine 40 that feeds back into the logic module 140 so as to continuously update the speed of the internal combustion engine 40. In order to ensure safe operation of the hybrid aircraft 10, there is provided a fail signal 200 which is used to safely land the hybrid aircraft 10 in the event that power fails or another event occurs which prevents the hybrid aircraft 10 from operating in accordance with an embodiment. In a rotor 24 failure event, the lift from rotors 72 is preferably capable of providing sufficient lift to safely land the aircraft 10.

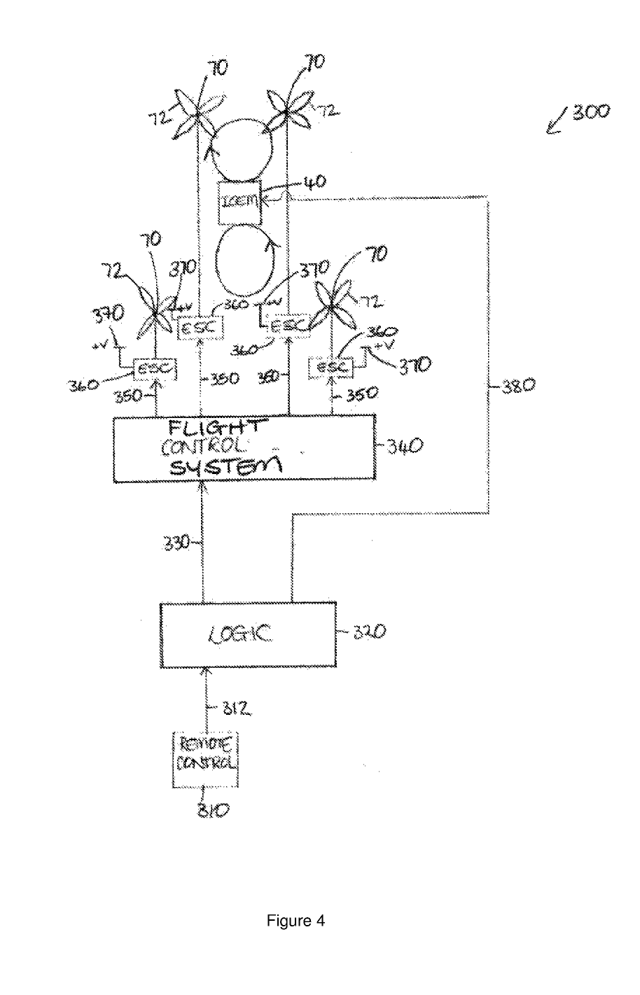

FIG. 4 illustrates the control system 300 in accordance with a further embodiment. The control system 300 receives a remote control signal 312 from a remote control device 310 or autonomous operation from an on-board computer system. This signal is received by a logic element 320. The logic element 320 splits the received signal 312 into a flight control signal 330 provided to the flight control system 340 and a throttle control signal 380. The flight control signal 330 is used by the flight control system 340 to predominantly control stability and manoeuvring of the aircraft by outputting speed control signals 350. Again the flight control system 340 may be an off-the-shelf flight control system. The speed control signals 350 are provided to electronic speed controllers 360 to control the speed of respective electric motors 60 to control the rotation speed of the rotors 72. Thus the rotors 72 are then rotated in accordance with the flight control signal 330.

The throttle control signal 380 is used to control the throttle of the internal combustion engine 40 to control the speed of the internal combustion engine 40 and thus the rotation speed of the rotors 24. The speed of the rotors 24 predominantly controls lift of the aircraft.

In an embodiment, the controller 100/300 is configured such that the throttle control signal 180/380 controls the internal combustion engine, so that the set of two rotors 24 provides a substantial component of an overall lift force applied to the hybrid aircraft and preferably the set of rotors 24 provide the majority of the overall lift force applied to the hybrid aircraft.

In an embodiment, the controller 100/300 is configured such that the speed control signal 150/350 for each electric motor 60 controls each respective electric motor to provide a contribution to the overall lift force applied to the hybrid aircraft. In an embodiment, the contribution to the overall lift of each electric motor driven rotor 72 is substantially constant. In an embodiment, the contribution to the overall lift of each electric motor driven rotor 72 is substantially as required to maintain each electric motor at an energy consumption efficient (idle) speed.

In an embodiment, the manoeuvring control is superimposed over the contribution of lift for each electric motor driven rotor signal, for each electric motor 60, in the speed control signals 150/350. The lift contribution of the electric motor driven rotors 72 will be considerably less than that in a standard multi-rotor drone because of the significant contribution to the overall lift by the rotors 24.

The electrical power drain from running the motors 60 is therefore significantly lower, allowing a slower discharge of the battery 46. This in turn allows a longer endurance time of the aircraft 10 in comparison to a same weight for weight comparable standard multi-rotor drone. Alternatively additional payload weight can be traded for a shorter endurance time.

In an embodiment the internal combustion engine may be coupled to a generator to provide or contribute to the electrical power provided to the electric motors 60. This may be used to supplement power provided by the battery 46, thereby even further slowing battery 46 discharge. For example, the generator may be configured to produce electrical power sufficient to power the energy efficient idle speed of the electric motors 60, with battery power used for stability and manoeuvring control.

In an embodiment logic module 140 is configured by selecting an angular velocity as the idle speed of the electric motors 60. In an embodiment the relationship between the angular acceleration of the electric motor driven rotors 72 as a function of instantaneous angular velocity is determined. The relationship between angular velocity and instantaneous current draw is determined. The relationship between instantaneous angular acceleration as a function of instantaneous current draw is determined for the other two relationships. An angular velocity which minimises electric motor idle current draw while maintaining a sufficiently high instantaneous angular acceleration at the resultant angular velocity is selected to ensure effective aircraft operability.

In an embodiment the logic module 140 is configured to control the electric motors 60 by adjusting the electronic speed control signal 150 from a signal which drives the electric motor 60 at the selected idle angular velocity. The electronic speed control signal 150 is adjusted equally such that the electric motor 60 with the lowest angular velocity is reduced by the logic module 140 to the selected idle angular velocity. The remaining speed control signals 150 to the remaining motors 60 are reduced equivalently such that effective thrust difference from that of the lowest angular rotation is maintained.

The effort set point for overall thrust (as a proportion of full thrust) is used to determine the thrust control signal 180 provided to control the speed of the internal combustion engine 40.

In effect the thrust T for idle flight is distributed amongst the rotors, with internal combustion engine rotor thrust being T_{I} and electric motor driven rotor thrust being T_{E}. In this case there are two internal combustion engine rotors and four electric motor driven rotors. So:

T=2T_{I}+4T_{E}

Thus: T_{I}=(T−4T_{E})/2

Accordingly when T_{E} is the idle thrust, it can be quite a low contribution to the overall thrust.

Further if one of the motors 60 needs to provide a burst of speed for manoeuvring or stability purposes the change in speed required for the required angular velocity is less than if the motor where spinning up from a stationary state. Further a burst of slowed speed (for a negative change in thrust) can simply be implemented by slowing the motor, which again reduces current draw and then the current draw to return to idle speed is also correspondingly less.

Further still, internal combustion engines are generally less responsive than electric motors, and thus if a sharp change in lift is required the electric motor driven rotors 72 can fill this thrust need whilst the internal combustion engine driven rotors 24 adjust their speed.

In a preferred for the control of the manoeuvring rotors 72 is such that it is additive only from the base idle speed. Yaw, pitch and roll manoeuvring is conducted by controlling the additional speed from idle of the respective rotors 72 to achieve the required manoeuvre. In one example, executing a yaw manoeuvre can be implemented by increase in speed of all of the rotors 72 that contribute to a common angular momentum on the desired yaw direction. However this can produce an increase in lift, which may not be desired if the altitude is to remain the same. This can be countered by a proportional decrease in the thrust of the rotors 24.

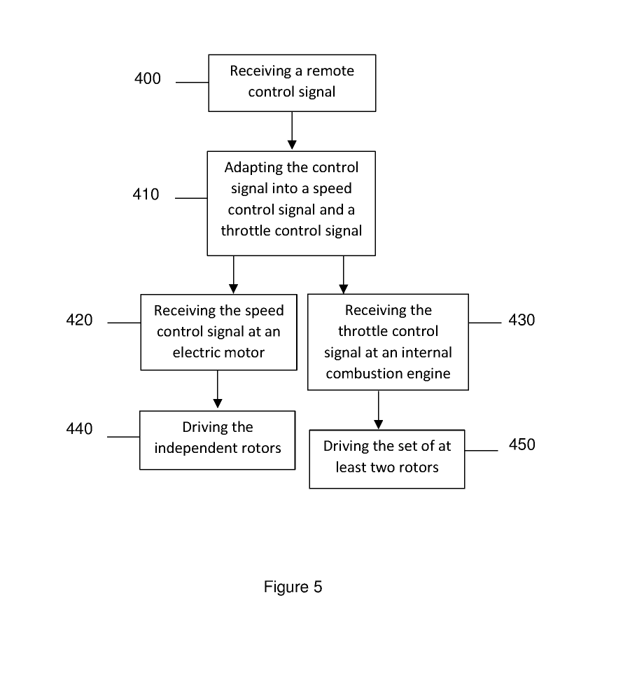

Referring to FIG. 5, there is illustrated a flow chart for operating a hybrid aircraft 10 in accordance with an embodiment of the present invention. The method comprises receiving a remote control signal at 400, then adapting the control signal so that it becomes one or more speed control signals and a throttle control signal at 410. The speed control signal is received at an electric motor at 420, a throttle control signal is received at an internal combustion engine at 430. The speed control signal is then used to drive the independent rotors at 440, and the throttle control signal is used to drive the set of at least two rotors at 450.

In some embodiments there may be more than one internal combustion engine, each of which rotates a rotor. In an embodiment the throttle control for the internal combustion engines may be the same or they may be independent. Independent throttle control would allow the rotors 24 to contribute to manoeuvring in the sense of providing forward or reverse directional trust.

In some embodiments there may be a different number of rotors driven by the internal combustion engine(s). In some embodiments the internal combustion engine driven rotors will not in combination be fully counter rotating to provide a neutral angular momentum. In an embodiment, a combined rotational force produced by the set of rotors driven by the internal combustion engine(s) may be counteracted by a combined angular momentum produced by the electric motor driven rotors.

In an embodiment, the system has a failure detector, which sends a failure signal to the flight control system in the event of a failure. In that case a failure of the internal combustion engine or the electric motors may be compensated for by the other(s).

In an embodiment the controller 100/300 or the logic module 140/320 may be implemented at least in part in the form of one or more computer programs for controlling a processor to execute the method described above. In an embodiment the computer programs are stored in non-volatile memory, such as an EEPROM or flash memory.

In an embodiment the direction of thrust of one or more of the electric motor driven rotors is controllable.

In an embodiment the aircraft 10 further comprises a forward thruster, such as a rotor directed to provide forward thrust.

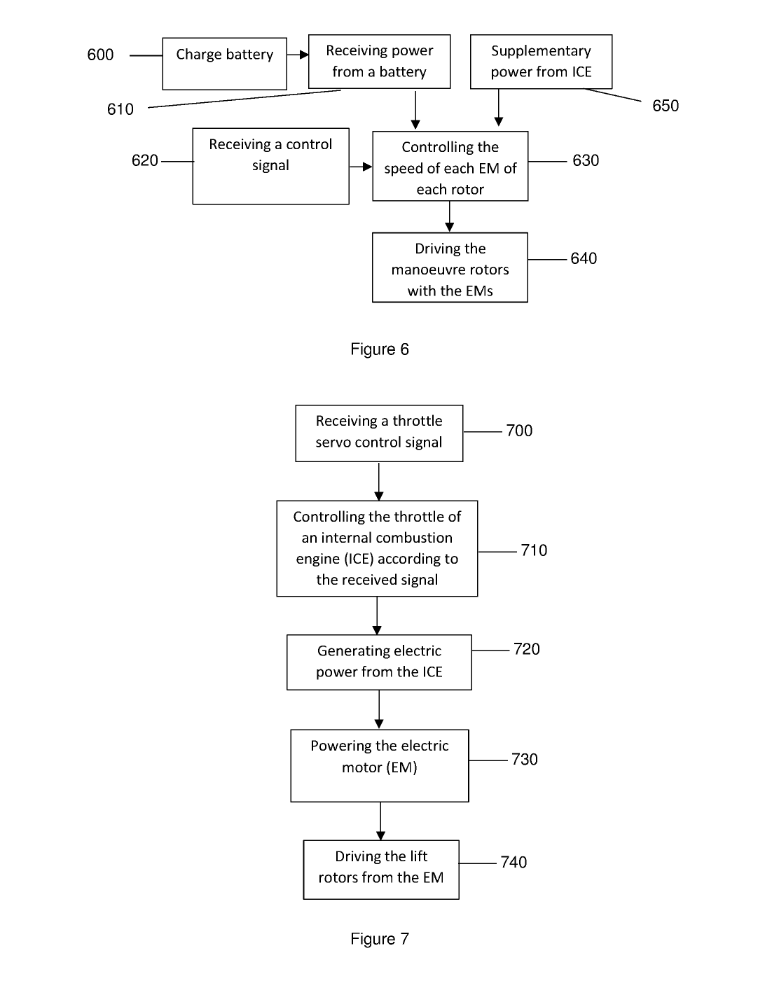

FIG. 6 illustrates an embodiment of powering the present invention in a simple form. The battery 46 can be either a single battery, or two batteries, one of which may be optional. Initially, the battery 46 is charged 600. The batteries 46 can be Lithium-ion Polymer (LiPo) rechargeable batteries or another form of rechargeable battery. The power from the batteries 46 powers the controller which controls each electric motor 60 of each rotor 72. A control signal is also received at 620, for controlling the speed of each electric motor 60 of each rotor 72 at 630. The control signal is then used to drive the electric motors 60, which then drive the manoeuvre rotors 640.

In a further embodiment of the present invention, electrical power can be generated from the internal combustion engine 40. One use of this is to recharge the battery 46 or to supplement the power requirement provided to the electric motors 60 as indicated by 650.

In a further development of this use of generated electric power, it can be used to drive electric motors for driving the lift rotors 24, instead of the mechanical drive from the internal combustion engine 40. FIG. 7 illustrates receiving a throttle servo control signal 700 which is used to control the throttle of an internal combustion engine (ICE) in accordance with the throttle servo control signal 710. Electric power is then generated from the ICE 720 and this is used to power the electric motor (EM) 730. The EM then drives the lift rotors 24 of the hybrid aircraft 740.

It is also possible to individually control the speed of the rotors 24. Generally the control will be so as to keep the thrust produced by them to be substantially the same, for example within +/−5% of each other. However it is possible to deliberately spin one of the rotors 24 at a slightly different speed to tilt (pitch) the aircraft and provide forwards or backwards directional thrust. (More thrust from the rear rotor will produce forwards thrust, and vice versa).

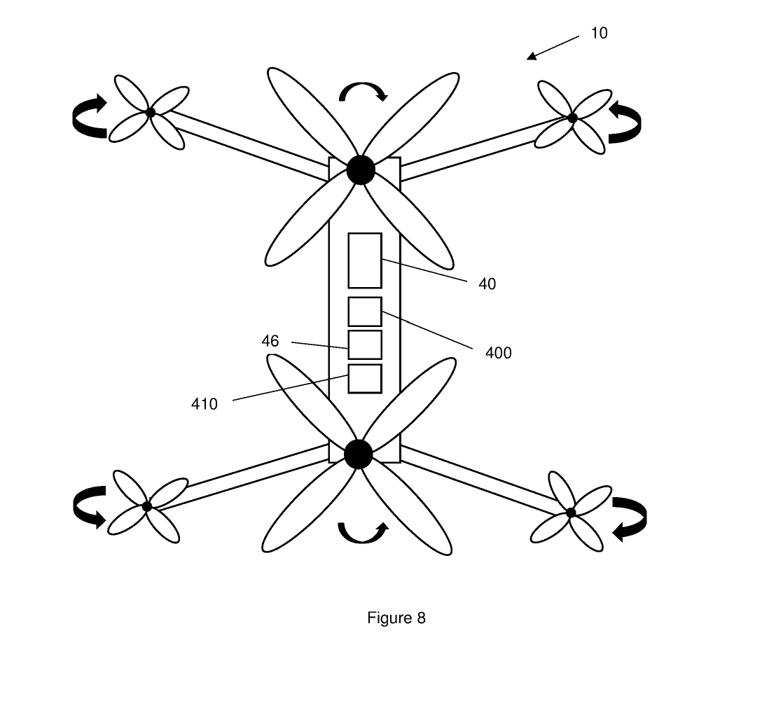

FIG. 8 illustrates a top view of a preferred configuration of the hybrid aircraft 10. An internal combustion engine (ICE) 40, a generator 400, battery(ies) 46 and circuitry 410 are present on the chassis 20 of the hybrid aircraft 10.

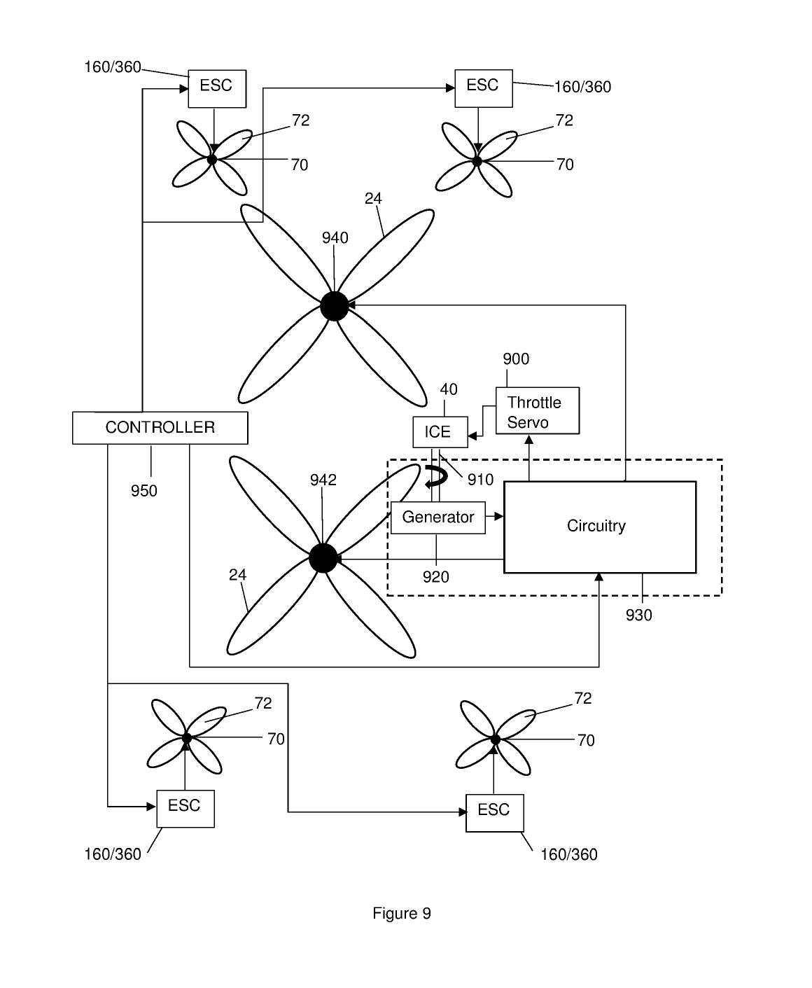

FIG. 9 illustrates a control system of a preferred embodiment of the hybrid aircraft 10. A throttle servomotor 900 controls the speed of the internal combustion engine (ICE) 40 which in turn rotates a shaft 910 which generates electric power via a generator 920. The electric power is used to provide power to circuitry 930, the output of which is used to drive the electric motors 940 and 942 mounted to the centres 22 of the rotors 24. A controller 950 is connected to circuitry 930 so as to provide control to the electric motors 940, 942, in order to drive the rotors 24 in a controlled manner. The controller 950 may be in the form of the combinations of flight control system 120 and logic 140, or logic and 320 flight control system 340 described above. The controller 950 also directly controls the electronic speed controllers 160/360 which control the electric motors 70 and the manoeuvre rotors 72 of the hybrid aircraft 10.

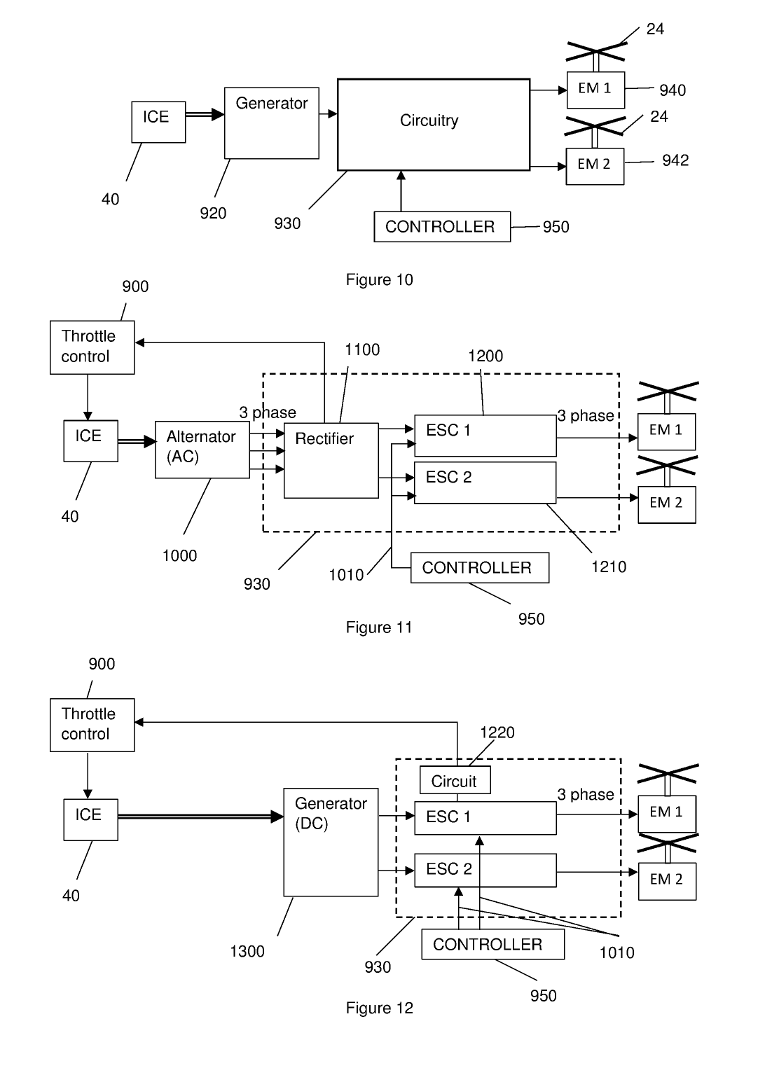

Various different embodiments of the circuitry 930 are shown in FIGS. 10 to 14, and described in more detail below. Generally speaking the circuitry 930 controls the throttle servomotor 900 based on the controller 950 input, and provides power from the generator 920 to the motors 940 and 942.

FIG. 10 illustrates a generic configuration of connecting the circuitry 930 to the generator 920, which may be either a DC generator, or an alternator (AC generator) with a control signal from the controller 950 being received by the circuitry 930, so as to control the signal used to drive the electric motors (EM) one 940 and two 940, which are providing lift to the hybrid aircraft 10.

FIG. 11 illustrates an embodiment where the generator 920 is an alternator 1000 which produces AC 3 phase power. An example alternator is a Sullivan™ S676-550U-01 (see http://www.sullivanuv.com/product-item/s676-550u-01/). In this embodiment, the circuitry 930 is inside a dashed box, and comprises a rectifier 1100 and electronic speed controllers (ESC) one 1200 and two 1210. An example rectifier is a Sullivan™ SSGNS-100A-01 (http://www.sulivanuv.com/product-item/SSGNS-100A-01/), which also comprises a regulator. The ESC one 1200 is used to control electric motor one 940, as already described. The ESC two 1210 is used to control electric motor two 940, as already described. The rectifier 110 supplies rectified power to both ESCs (1200 and 1210), and the ESCs also receive a control signal 1010 from the controller 950 so as to control the ESCs and provide a three phase output to drive the EM1, 940 and EM2, 940. The circuitry 930 further comprises a control signal 1020 from the rectifier 1100 to the throttle servo control 900 so as to increase or decrease the output from the ICE 40 in order for the alternator 1000 to meet power demands as required by the ESCs 1200 and 1210 to drive the motors 940 and 942 according to the control signal 1010.

FIG. 12 illustrates another embodiment, in which the generator 920 is a DC generator 1300. The DC power produced by the generator 1300 is received by the circuitry 930, which comprises two ESCs 1200 and 1210 and a circuit 1220. The circuit 1220 is used to control the throttle control 900, which in turn controls the ICE 40, which in turn controls the power produced by the DC generator 1000 so as to meet power demands as required by the ESCs 1200 and 1210 to drive the motors 940 and 942 according to the control signal 1010. The circuit 1220 may be a feedback or feed forward control circuit.

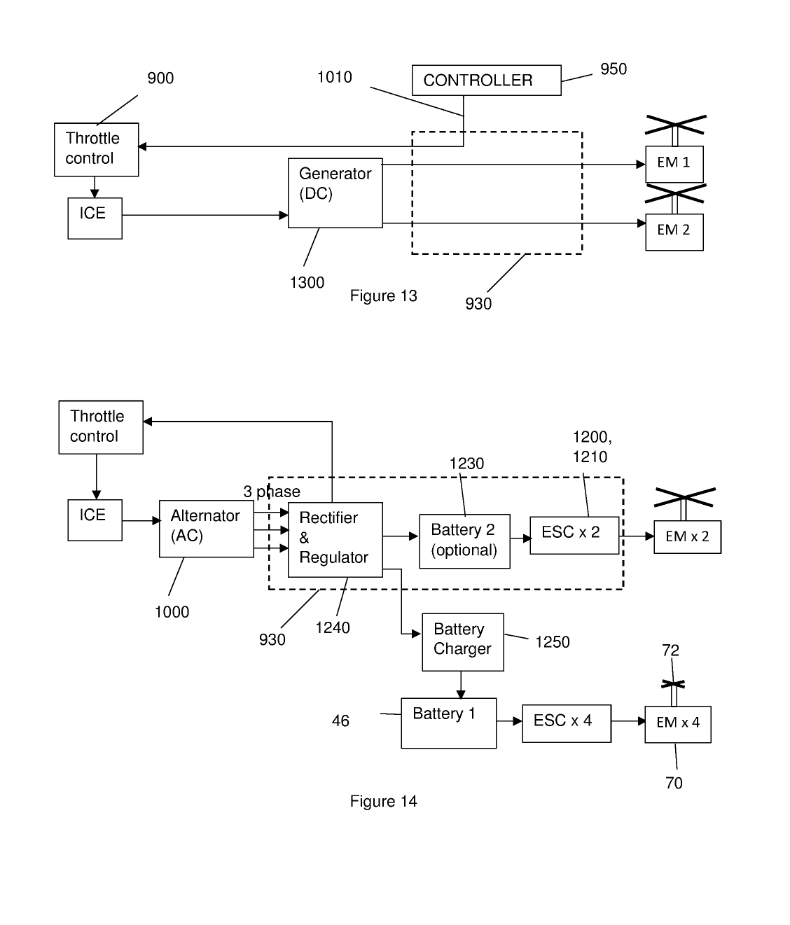

It is also possible to implement the circuitry 930 as a direct connection from the DC generator 1300 to the EM1 940 and EM2, 942 as shown in FIG. 13. The control signal 1010 from the controller 950 directly controls the throttle control 900. Thus in this case the circuitry 930 comprises the respective connections.

In a preferred embodiment, as shown in FIG. 14, which is based on the embodiment of FIG. 11, there is an optional battery 1230 within the circuitry 930, which can be used to provide power to the lift ESCs 1200, 1210 instantaneously, during initial start up, when more power is required than the ICE can provide due to ramping up of the ICE. Battery 1230 can also provide a backup in case of the failure of the ICE. The alternator 1000 provides a 3 phase signal to a rectifier and regulator 1240, which then provides a rectified (DC) signal to both the optional battery 1230. The rectifier and regulator 1240 may also have a second output which can be connected to a battery charger 1250. The battery charger 1250 may be used to charge the main battery 46, during the idling of the manoeuvre rotors 72 and or to power the manoeuvre rotors 72 during idling. During manoeuvring the battery 46 is used.

Modifications may be made to the present invention within the context of that described and shown in the drawings. Such modifications are intended to form part of the invention described in this specification.

1. A hybrid aircraft comprising:
at least three independent electric motors each arranged to drive a respective rotor;
an internal combustion engine arranged to drive a set of at least two horizontally spaced apart rotors;
a controller for receiving a flight control signal and for outputting a speed control signal for each electric motor and a throttle control signal for the internal combustion engine, wherein the throttle control signal determines the speed of rotation of the set of at least two horizontally spaced apart rotors.

2. A hybrid aircraft according to claim 1, wherein set of at least two rotors comprises only two rotors positioned longitudinally spaced apart relative to a body of the aircraft.

3. (canceled)

4. A hybrid aircraft according to claim 2, wherein the internal combustion engine drives the two rotors so as to be counter rotating.

5. A hybrid aircraft according to claim 2, wherein axes of rotation of the two rotors are vertical and fixed.

6. A hybrid aircraft according to claim 2, wherein the drive of the counter rotating two rotors is by a mechanical drive train.

7. (canceled)

8. A hybrid aircraft according to claim 1, wherein the controller is configured such that the throttle control signal controls the internal combustion engine, so that the set of at least two rotors provides a substantial component of an overall lift force applied to the hybrid aircraft.

9. A hybrid aircraft according to claim 1, wherein the controller is configured such that the speed control signal for each electric motor controls each respective electric motor to provide a manoeuvring thrust for the hybrid aircraft according to the flight control signal.

10. A hybrid aircraft according to claim 1, wherein the speed control signal for each electric motor controls each respective electric motor to provide a contribution to the overall lift force.

11. A hybrid aircraft according to claim 1, wherein the controller comprises a flight control system for determining combined lift and manoeuvring control signals for controlling flight of the hybrid aircraft.

12. (canceled)

13. A hybrid aircraft according to claim 11, wherein the contribution to the overall lift of each electric motor driven rotor is substantially as required to maintain each electric motor at an energy consumption efficient speed.

14. A hybrid aircraft according to claim 11, wherein the manoeuvring control signal is superimposed over the contribution of lift for each electric motor driven rotor signal, for each electric motor.

15. A hybrid aircraft according to claim 1, wherein the speed control signal for each electric motor varies substantially only for stabilisation and manoeuvring purposes.

16. (canceled)

17. A hybrid aircraft according to claim 1, wherein the controller comprises a logic element for splitting the speed control signals from the flight control system into the speed control signals for each electric motor and the throttle control signal.

18. A hybrid aircraft according to claim 1, wherein the controller comprises a logic element for splitting the flight control signal into a control signal input into a speed control system and the throttle control signal.

19. (canceled)

20. (canceled)

21. A hybrid aircraft according to claim 1, wherein the diameters of each of the set of at least two rotors are larger than the diameters of the at least three independent electric motor driven rotors.

22. A hybrid aircraft according to claim 2, wherein the drive of the two counter rotating rotors is by the internal combustion engine motivating an electrical generator which in turn drives at least one electric motor configured to mechanically drive the counter rotating rotors.

23. A controller system for a hybrid aircraft, said controller system comprising:
a receiver of a flight control signal;
a flight control system for creating a combined lift and manoeuvring signal for each of at least three electric motors from the flight control signal;
a logic element for creating a lift control signal derived from the combined lift and manoeuvring signal or the control signal, whereby in use the combined signals control the speed of the respective electric motor so as to rotate a respective rotor and the lift control signal controls the speed of rotation of two or more lift generating rotors.

24. The controller according to claim 23, wherein the speed of rotation of the two or more lift generating rotors is determined by a throttle of an internal combustion engine.

25. The controller according to claim 23, wherein the throttle is controlled by the lift control signal.

26. (canceled)

27. (canceled)

28. A method for operating a hybrid aircraft, said method comprising:
receiving a flight control signal;
adapting the control signal into a speed control signal for each of a plurality of independent electric motors for driving a respective rotor and a throttle control signal for driving a set of at least two horizontally spaced apart rotors;
driving the respective rotors using the plurality of electric motors each at a speed according to the respective speed control signal;
driving the set of at least two horizontally spaced apart rotors at a speed according to the throttle control signal.

29. A computer program in the form of instructions stored in a non-volatile manner in a hybrid aircraft for controlling a processor to:
receive a flight control signal;
adapt the control signal into a speed control signal for each of a plurality of independent electric motors for driving a respective rotor and a throttle control signal for an internal combustion engine for driving a set of at least two rotors.

30. (canceled)

31. (canceled)

32. A hybrid aircraft comprising:
at least three independent electric motors each arranged to drive a respective rotor for manoeuvring the hybrid aircraft;
at least two electric motor powered horizontally spaced apart rotors with fixed vertical axes of rotation only for lifting the hybrid aircraft;
an internal combustion engine arranged to drive a generator;
wherein an electric motor for driving the or for each of the at least two rotors is powered by the generator.

33. A hybrid aircraft comprising:
an internal combustion engine arranged to drive a generator;
a controller for outputting a control signal for controlling the speed of rotation of at least three electronic motor powered rotors for manoeuvring the hybrid aircraft, and for outputting a signal for controlling the speed of rotation of at least two electric motor powered rotors for lifting the hybrid aircraft; wherein an electric motor for driving the or for each of the at least two rotors is powered by the generator.

34. A hybrid aircraft according to claim 33, wherein the rotors for lifting the hybrid aircraft provide substantially more lift per revolution per minute than the lift produced by the rotors for manoeuvring the hybrid aircraft.

35-50. (canceled)
